(19) United States
(12) Patent Application Publication
(10) Pub. No.: US 2019/0239676 A1
(43) Pub. Date: Aug. 8, 2019

(54) DECONSTRUCTIBLE COFFEE FILTER SUPPORT STRUCTURE

(71) Applicant: BLACK RIFLE COFFEE COMPANY LLC, Salt Lake City, UT (US)

(72) Inventors: Jeffrey B. Kirkham, Draper, UT (US); Evan Hafer, Salt Lake City, UT (US)

(21) Appl. No.: 16/263,669

(22) Filed: Jan. 31, 2019

Related U.S. Application Data
(60) Provisional application No. 62/625,727, filed on Feb. 2, 2018.

(51) Int. Cl. A47J 31/02; A47J 31/08; B01D 29/085; B01D 29/07; B01D 46/00

(52) U.S. Cl. CPC A47J 31/02; A47J 31/08; B01L 2300/0681; B01D 29/07; B01D 46/0005; B01D 29/085

(57) ABSTRACT

A filter support structure is provided. This filter support structure includes a multi-sided funnel, which is comprised of a plurality of interconnecting walls where each wall forms one side of the multi-sided funnel. Each wall is connected to two adjoining walls via a latching mechanism. The filter support structure further includes a base support that includes a central opening. The central opening is shaped to correspond to a number of walls that are included in the plurality of walls of the multi-sided funnel. A portion of the multi-sided funnel is fittable within the central opening of the base support.

### CROSS-REFERENCE TO RELATED APPLICATIONS

This application claims priority to U.S. Provisional Application Ser. No. 62/625,727, filed on Feb. 2, 2018 and entitled “DECONSTRUCTIBLE COFFEE FILTER SUPPORT STRUCTURE,” the entirety of which is incorporated herein by reference.

### BACKGROUND

There are many different types of filter support structures currently in existence. By way of example, there are support structures for oil filters, water filters, and food processing filters, just to name a few.

In today's world, many people drink coffee. Indeed, people drink coffee at home, in the office, and even while driving. Although many people drink coffee from the comforts of a home or office, there are many other people that engage in rugged outdoor activities. Although these people are in a rugged environment, they still desire to drink coffee. To do so, they need a coffee filter support structure. Accordingly, there is a substantial need in the field to provide for a high-quality, high-durability coffee filter support structure that is able to withstand any type of environmental condition, even rugged or extreme conditions, and that is easy to pack in a compact way.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include a filter support structure. In some embodiments, a filter support structure includes a multi-sided funnel, which is comprised of a plurality of interconnecting walls where each wall forms one side of the multi-sided funnel. Each wall is connected to two adjoining walls via a latching mechanism. The filter support structure further includes a base support that includes a central opening. The central opening is shaped to correspond to a number of walls that are included in the plurality of walls of the multi-sided funnel. A portion of the multi-sided funnel is fittable within the central opening of the base support.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example coffee filter support structure.

FIG. 2 illustrates a base support of a coffee filter support structure.

FIG. 3 illustrates a support wall for a coffee filter support structure.

FIG. 4 illustrates an example container for storing filtered liquids.

FIG. 5 illustrates an example configuration for using the base support on a liquid container.

FIG. 6 illustrates an example configuration for using the coffee filter support structure.

FIG. 7 illustrates a profile view of an example configuration for using the coffee filter support structure.

FIG. 8 illustrates another profile view of the example configuration.

FIG. 9 illustrates the various different parts of an example coffee filter support structure.

FIG. 10 illustrates the various different parts from a different perspective.

FIG. 11 illustrates how the various different parts can be disassembled.

FIG. 12 illustrates another view of how the various different parts can be disassembled.

FIG. 13 illustrates yet another view of how the various different parts can be disassembled.

### DETAILED DESCRIPTION

Disclosed embodiments are directed to a deconstructible coffee filter support structure formed from a plurality of detachable components. In particular, the support structure includes a base support that is structured to allow steam to be slowly released from a liquid container while liquid (e.g., coffee) is being filtered. The support structure also includes a plurality of wall members that are able to be interlocked and that, when interlocked, form a multi-sided funnel for guiding liquid into the liquid container. Of note, this multi-sided funnel is structured to be able to support a coffee filter. As a result, a user is able to place the coffee filter support structure on a liquid container, place a filter within the multi-sided funnel, and pour liquid into the multi-sided funnel. The liquid will be filtered by the filter and will enter the liquid container. If the liquid is hot enough for steam to be produced, then the base support is structured to allow some of that steam to exit the liquid container via the base support. Accordingly, the present embodiments are directed to a high-quality, high-durability filter support structure. This filter support structure is capable of being quickly assembled and disassembled and is suitable for use in any type of environment, including extreme and rugged environments.

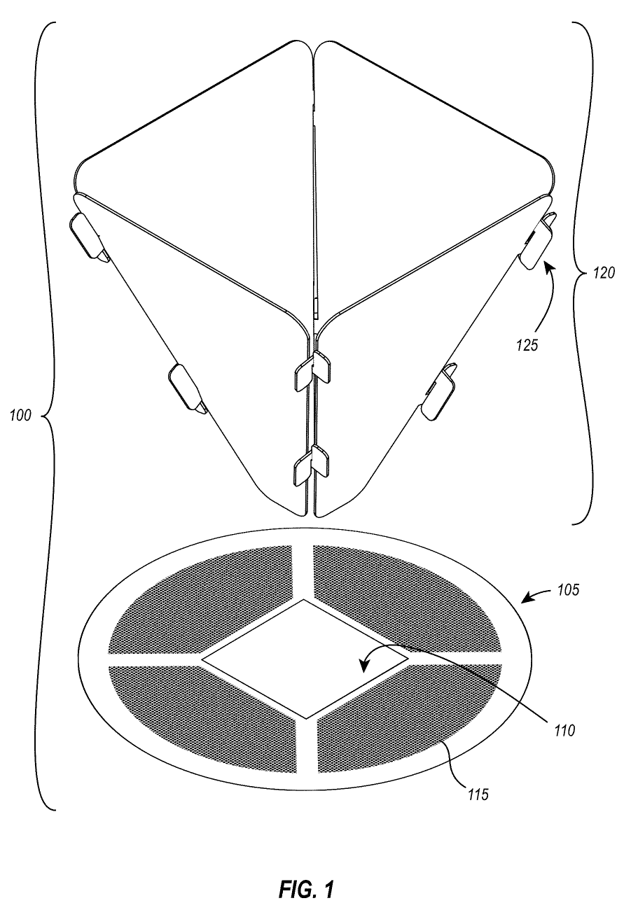

Attention will now be directed to FIG. 1. Here, a filter support structure 100 is presented. As illustrated, this filter support structure 100 initially includes a base support 105. This base support 105 is roughly circular in shape so that it can fit on any type of liquid container, as will be discussed in more detail later. Of note, other embodiments include base supports that are of different shapes (e.g., triangle, square, rectangle, pentagon, hexagon, heptagon, octagon, or any sided shape).

The base support 105 also includes an opening 110. This opening 110 is structured to allow a multi-sided filter (to be discussed momentarily) to rest within the opening 110.

The base support 105 also includes a plurality of steam release vents 115. In the illustration presented in FIG. 1, the steam release vents 115 are portrayed as a plurality of holes in the base support 105. It will be appreciated, however, that the steam release vents 115 may be of any type. For example, the steam release vents 115 may be embodied as a hingable/closeable opening such as a check valve. Alternatively, the steam release vents 115 may be embodied as a latchable vent that is capable of remaining closed until the latch is released. As a result, any resulting steam may be trapped inside until such time as a user deems it necessary to release the steam by opening the vent using the latch.

In yet another embodiment, the release vents 115 are embodied as a plurality of corresponding openings on two or more layers of the base support 105, wherein at least one of the layers is rotatable such that the release vents 115 are opened when the rotatable layer is in a first position, and the release vents 115 are closed when the rotatable layer is in a second position. Accordingly, from this disclosure, it will be appreciated that the steam release vents 115 may take on many different forms and the portrayal given in FIG. 1 should not be construed as being limiting.

The filter support structure 100 also includes a multi-sided funnel 120. As illustrated in FIG. 1, the multi-sided funnel 120 includes a plurality of wall portions that are interlocked via a plurality of locking mechanisms 125. When joined, the plurality of wall portions form a funnel structure that is able to support a filter. Of note, the filter may be placed within the inner wall area of the multi-sided funnel 120. As a result, the filter will be properly supported in all areas by each wall of the multi-sided funnel 120. It will be appreciated that the plurality of wall portions may include 3 wall portions, 4 wall portions, 5 wall portions, 6 wall portions, and so on. Accordingly, while FIG. 1 shows 4 wall portions, the embodiments are not limited only to 4 wall portions.

When the base support 105 is placed on top of a liquid container, the multi-sided funnel 120 will be partially inserted into the opening 110. As a consequence, the base support 105 provides a bottom support for the multi-sided funnel 120. Such a configuration will be discussed in more detail with regard to some of the later figures. It will be appreciated that some embodiments can operate without the base support 105. That is, the multi-sided funnel 120 may be placed directly over top of a container such that the sides of the multi-sided funnel 120 butt up against the sides of the opening of the container. Because the multi-sided funnel 120 flares outward, the multi-sided funnel 120 will be prevented from falling entirely within the container. Accordingly, in some embodiments, the filter support structure 100 can omit the base support 105. In cases where the base support 105 is not used, then the multi-sided funnel 120 may include extending arms that extend outward to as to prevent the multi-sided funnel 120 from falling into the container. In some embodiments, the locking mechanisms 125 can operate as an integrally connected portion of these arms. In other embodiments, the arms extend from and/or are extendable from the sides (independent of the locking mechanisms 125) in an embodiment that is not presently shown. The arms may be integrally connected to the sides and/or may be entirely separate and detachable portions of the structure that are connectable to the sides and/or locking mechanisms.

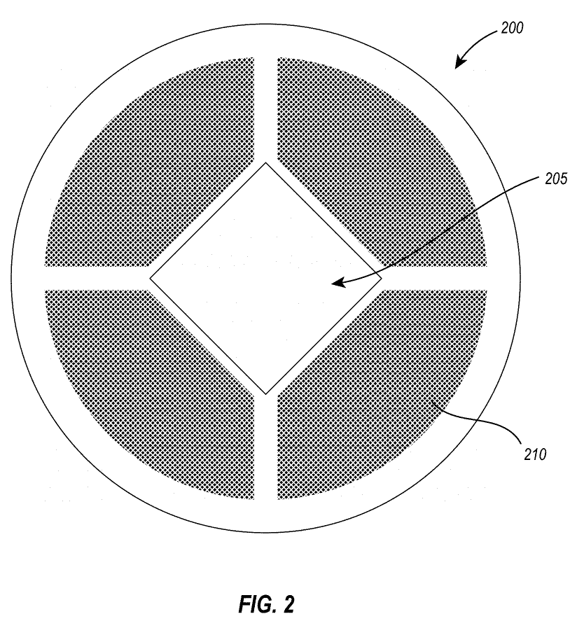

Attention will now be directed to FIG. 2, which illustrates a base support 200. Base support 200 is representative of the base support 105 of FIG. 1. Just as was presented in FIG. 1, the base support 200 includes an opening 205 and a plurality of steam release vents 210.

It will be appreciated that the configuration of the opening 205 matches the configuration of a corresponding multi-sided funnel (e.g., the multi-sided funnel 120 of FIG. 1). For instance, the multi-sided funnel 120 of FIG. 1 included four different sides. In a corresponding manner, the opening 205 (and the opening 110 of FIG. 1) is shaped to include four distinct sides. In other words, the opening 205 is shaped as a square. Accordingly, in some embodiments, the opening 205 is shaped to correspond to the number of sides that are included in a corresponding multi-sided funnel.

Up to this point, the Figures have portrayed an embodiment in which the multi-sided funnel is comprised of four walls. It will be appreciated, however, that the embodiments should not be thusly limited. Indeed, the multi-sided funnel may be comprised of any number of walls and the opening 205 may be shaped in a corresponding manner. As a result, while the Figures show an example scenario where four walls are being used for the multi-sided funnel, the embodiments should not be limited strictly to such a configuration and can, in some embodiments, include fewer than 4 sides (e.g., 3 sides) or more than 4 sides (e.g., 5, 6, or another number of sides).

Furthermore, those skilled in the art will appreciate that the walls of the multi-sided funnel need not be planar, as in the embodiment shown, and other configurations for the walls are within the scope of this disclosure. For example, in some embodiments, the walls of the multi-sided funnel are curved such that, when the walls are interlocked, the multi-sided funnel forms the shape of a funnel or truncated cone. Accordingly, in such embodiments, the shape of the opening of the base support will be substantially circular or elliptical for receiving the cone-shaped multi-sided funnel.

In some embodiments, the walls may have a planar/flat shape near a bottom portion (i.e. the portion inserted into the opening 205) while the top portion can be curved. For instance, near the bottom, the connection of all of the walls can result in a square shaped opening. Near the top, however, the walls can be curved, resulting in a circular shaped opening.

In some embodiments, the opening 205 is sized large enough to enable at least a portion of the assembled multi-sided funnel to pass through the opening. For example, in some embodiments, the opening 205 has a diameter of 10 mm, which enables the assembled multi-sided funnel to rest on the opening 205 with a bottom portion of the multi-sided funnel passing through the opening. In some embodiments, the opening has a diameter spanning a range of at least 8 mm but less than 30 mm.

The plurality of steam release vents 210 was introduced earlier with respect to the plurality of steam release vents 115 of FIG. 1. It will be appreciated that these steam release vents 210 may be formed through use of a variety of different processes. For example, the plurality of steam release vents 115 may be formed by acid etching the base support 200. Alternatively, the steam release vents 115 may be formed by a hole punching device, by a laser, or by any other process suitable for creating a steam release vent. The small diameter size of the holes is also beneficial for keeping small particles and bugs out of the coffee cup during preparation. Forming holes in the base support 200 also decreases the weight of the base support 200. Although not shown, the walls can also be configured with similar type holes.

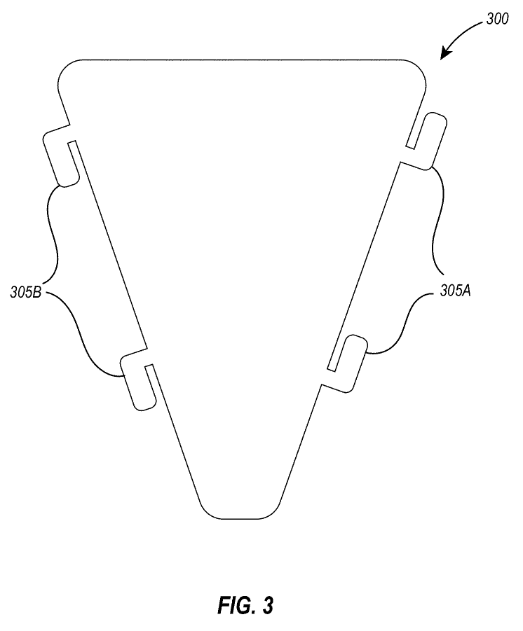

Turning now to FIG. 3, FIG. 3 illustrates one of the walls 300 that form the multi-sided funnel 120 of FIG. 1. As illustrated, the wall 300 is shaped generally in a triangular manner, meaning that the top portion is wider than the bottom portion. Because of this configuration, when the wall 300 is interconnected with the other walls of the multi-sided funnel, the multi-sided funnel will direct liquid to a narrow opening at its base. In this embodiment, wall 300 is flat with regard to its thickness dimension (e.g., the dimension popping outward or inward of the Figures sheet). In some embodiments, however, wall 300 may be curved in the thickness dimension. In some embodiments, the bottom portion of the triangle shape may be flat in the thickness dimension while the top portion of the triangle shape may be curved in the thickness dimension.

The walls 300 can be manufactured out of different materials, such as, but not limited to plastics and various metals (e.g., aluminum, tin, aluminum alloys, and so forth). The walls 300 can also be manufactured to have different thicknesses, to accommodate different needs and preferences, from less than 0.5 millimeters to greater than 1 millimeter.

The wall 300 also includes locking mechanisms 305A and 305B. Here, these locking mechanisms 305A and 305B are designed to allow the wall 300 to interlock with the other walls of the multi-sided funnel, as was illustrated in FIG. 1. Specifically, the locking mechanisms 305A and 305B are embodied as tabs which include locking channels and which extend from the sides of the wall 300. The tabs are oriented in opposite directions such that the locking channels of the tabs interface with and become latched to the tabs of other walls when the walls are in an interlocked position.

In the illustrated embodiment, the wall 300 includes two tabs which comprise locking mechanism 305A and two tabs which comprise locking mechanism 305B. However, this configuration is not the only configuration, and it will be appreciated that locking mechanisms 305A and 305B of wall 300 may include any number of tabs. For example, in some implementations, the locking mechanisms 305A and 305B include a single elongated tab and locking channel for interlocking with other walls (or a single elongated tab with a plurality of locking channels). In other implementations, the locking mechanisms 305A and 305B include three or more tabs and three or more locking channels for facilitating connection with other walls.

When the number of side walls are even, they can be configured the same, such that the locking mechanisms match up. However, for odd numbers of walls at least one of the walls will have a different configuration of locking mechanisms to interlock with the opposing side walls. Accordingly, those skilled in the art will appreciate that the locking mechanisms 305A and 305B of the wall 300 allow the wall 300 to removably interlock with other walls of the multi-sided funnel.

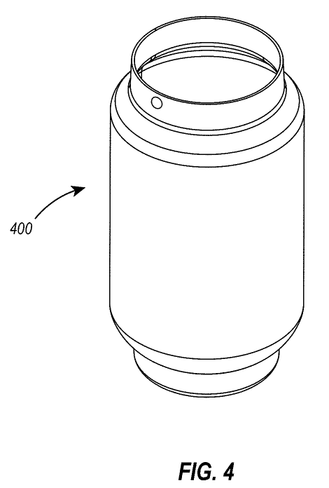

Turning briefly to FIG. 4, FIG. 4 illustrates an example liquid container 400. Such a liquid container 400 is designed to hold any type of liquid. Accordingly, the liquid container 400 is an example only and should not be considered as limiting on the disclosed embodiments.

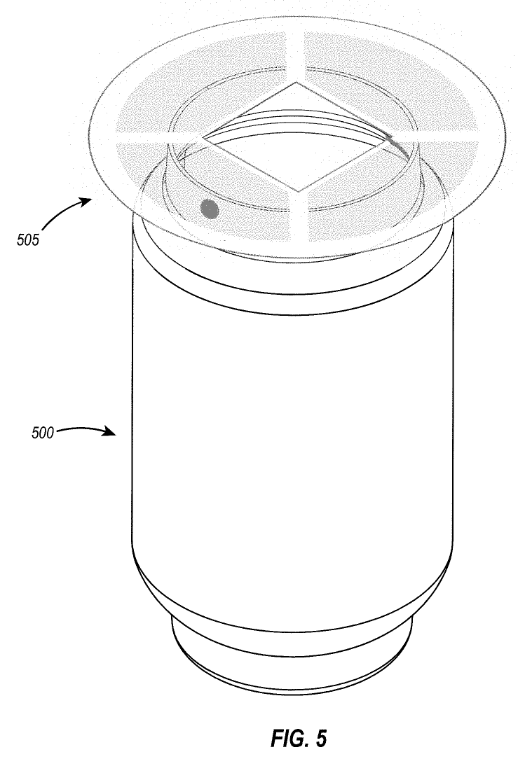

FIG. 5 illustrates a liquid container 500 and a base support 505. Base support 505 is representative of the base support 200 of FIG. 2 and the base support 105 of FIG. 1. As shown, the base support 505 is structured to fit over top of the opening of the liquid container 500.

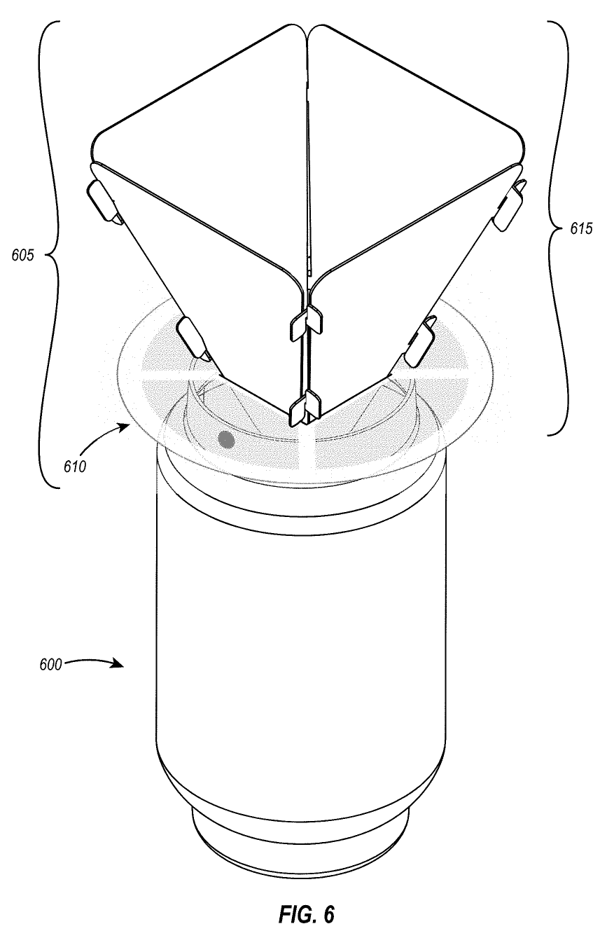

FIG. 6 illustrates a liquid container 600 and a filter support structure 605. The filter support structure 605 is representative of the filter support structure 100 of FIG. 1. Here, the filter support structure 605 includes a base support 610 and a multi-sided funnel 615. These components are representative of the components that were presented earlier.

As can be seen from FIG. 6, the base support 610 is resting over top the opening of the liquid container 600. Further, the multi-sided funnel 615 is resting within the opening (e.g., the opening 110 of FIG. 1 and the opening 205 of FIG. 2) of the base support 610. As a result, the base support 610 is providing a base for the multi-sided funnel 615. When a filter is placed within the inner wall area of the multi-sided funnel 615, then liquid can be poured onto the filter and the filtered liquid will be directed into the liquid container 600 by the walls of the multi-sided funnel 615.

Furthermore, as can be seen in FIG. 6, the base support 610 is positioned over the liquid container 600 such that at least some of the steam vents are positioned over top of the opening of the liquid container. Accordingly, if the liquid is hot enough such that steam is produced, then some of the steam is able to escape from the opening of the liquid container 600 through the plurality of steam vents included in the base support 610. It will be appreciated that some embodiments omit the base support 610 such that the multi-sided funnel 615 fits directly into the opening of the liquid container 600.

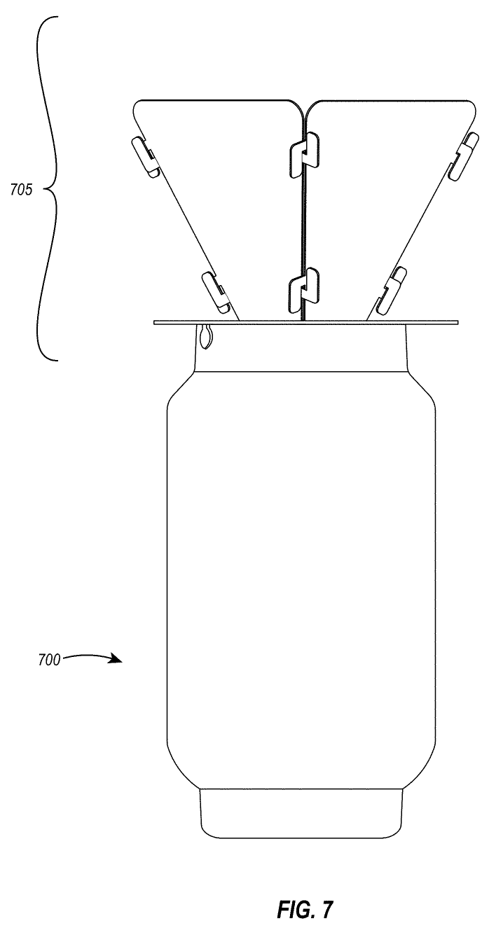

FIG. 7 illustrates a profile view of the configuration that was presented in FIG. 6. Here, there is a liquid container 700 and a filter support structure 705. As illustrated, the multi-sided funnel is secured within the opening of the base support. When a filter is placed in the inner wall area of the multi-sided funnel, then liquid can pass through the filter and be directed to the liquid container 700. Accordingly, the filter support structure 705 provides a highly durable structure for filtering liquids. Additionally, this structure is easily assembled and disassembled on demand. As a result, the filter support structure may be used in a variety of environments and may be transported in a convenient manner (i.e. the filter support structure, when disassembled, is highly compact and portable).

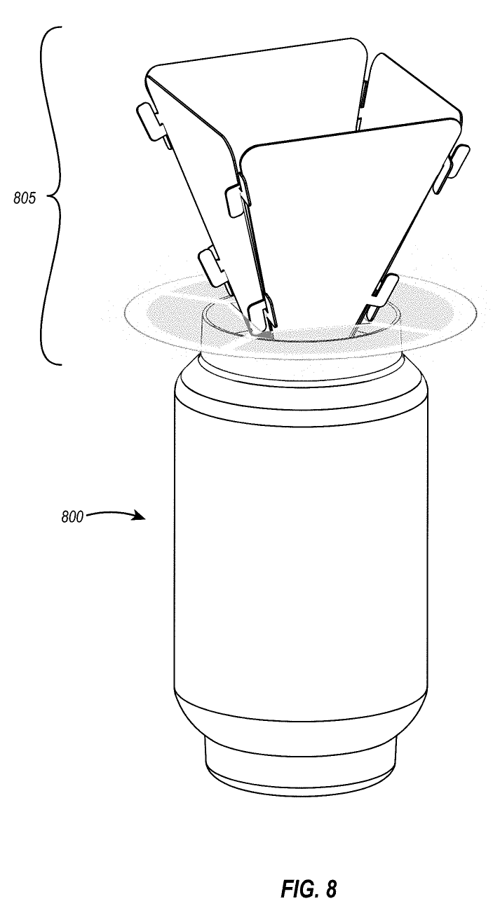

FIG. 8 illustrates another profile view (slightly inclined) of the configuration that was presented in FIGS. 6 and 7. Here, as before, there is a liquid container 800 and a filter support structure 805.

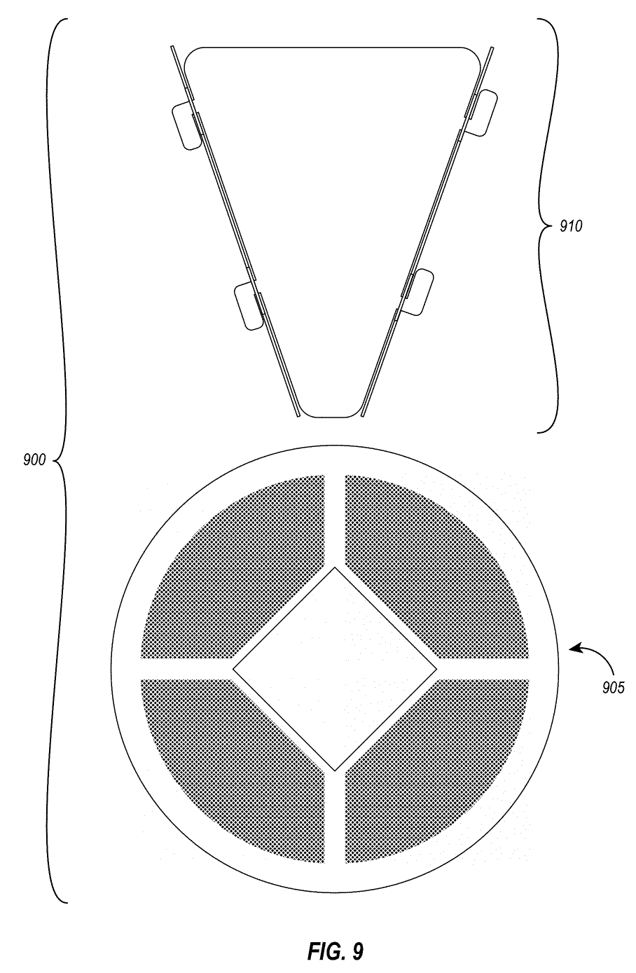

FIG. 9 shows a filter support structure 900 that includes the base support 905 and a multi-sided funnel 910. In this scenario, the filter support structure 900 is no longer positioned over top of a liquid container.

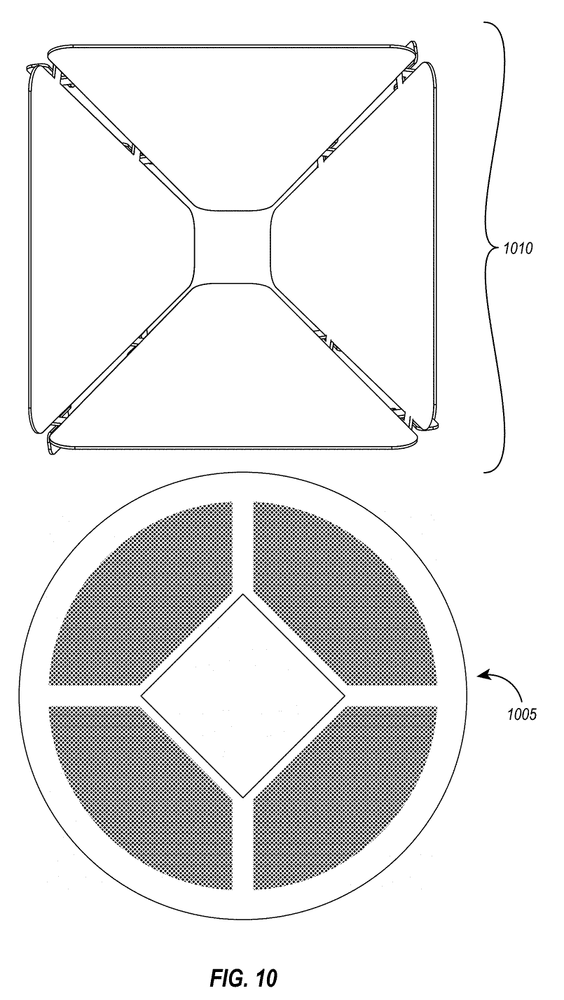

FIG. 10 shows a top aerial view of both a base support 1005 and the multi-sided funnel 1010. As shown, the multi-sided funnel 1010 is able to direct liquid to a small opening at its base. Because the multi-sided funnel 101 directs liquid in such a manner, a user need not be precise in how he/she pours a liquid.

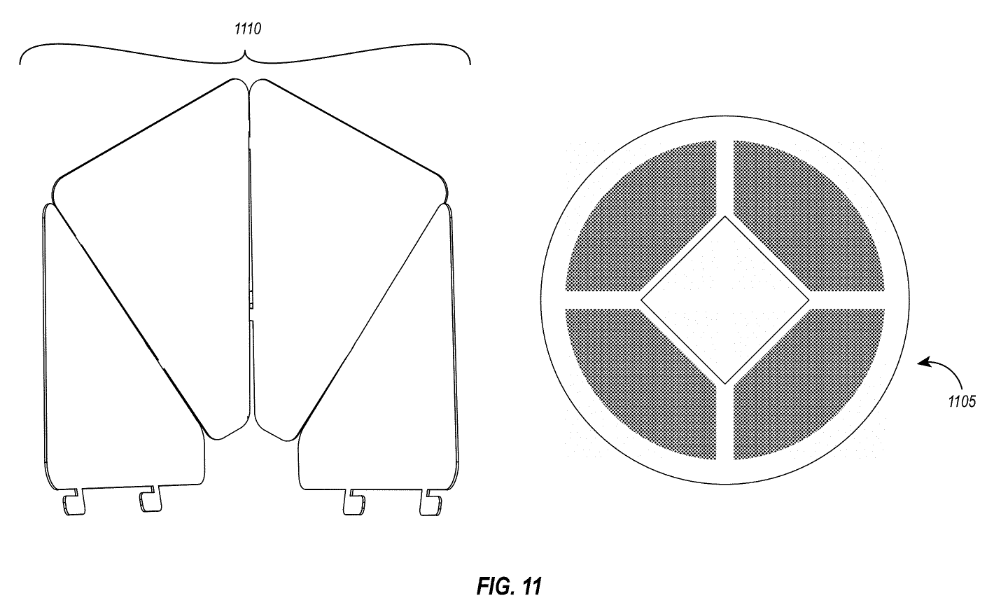

FIG. 11 illustrates a scenario that includes a base support 1105 and a multi-sided funnel 1110. In this scenario, the multi-sided funnel 1110 has been partially disassembled. As discussed earlier, each wall in the multi-sided funnel 1110 includes a plurality of locking mechanisms. When the walls are interlocked together, the multi-sided funnel 1110 is formed. The multi-sided funnel 1110 may be disassembled, as shown in FIG. 11 in which the multi-sided funnel 1110 is partially disassembled, with one set of locking mechanisms between two of the walls of the multi-sided funnel 1110 being disconnected.

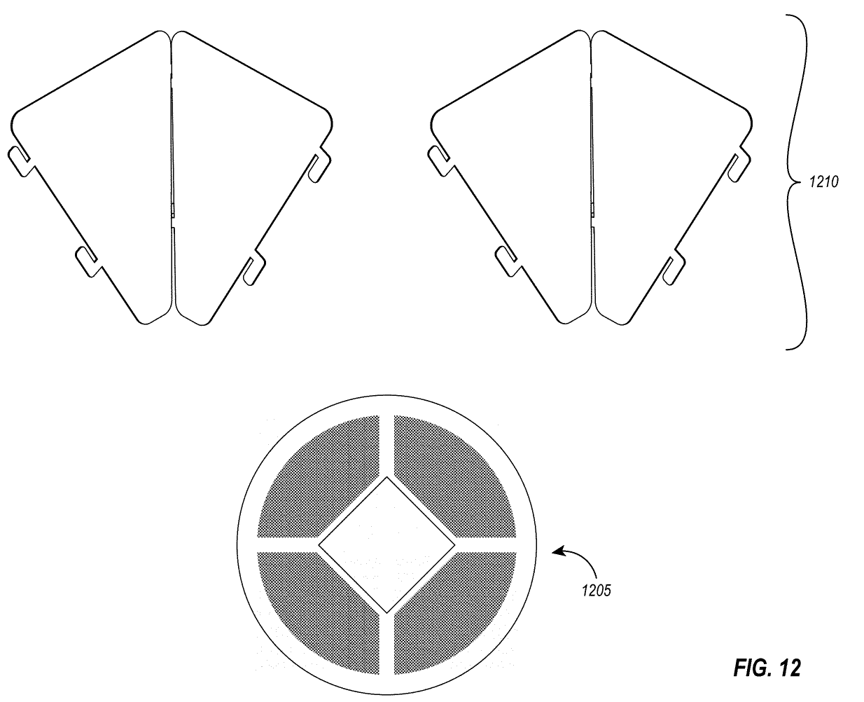

FIG. 12 shows another example scenario in which a multi-sided funnel has been partially disassembled. Here, FIG. 12 shows a base support 1205 and a multi-sided funnel 1210 that has been partially disassembled. In particular, two sets of locking mechanisms between four of the walls of the multi-sided funnel 1210 have been disconnected.

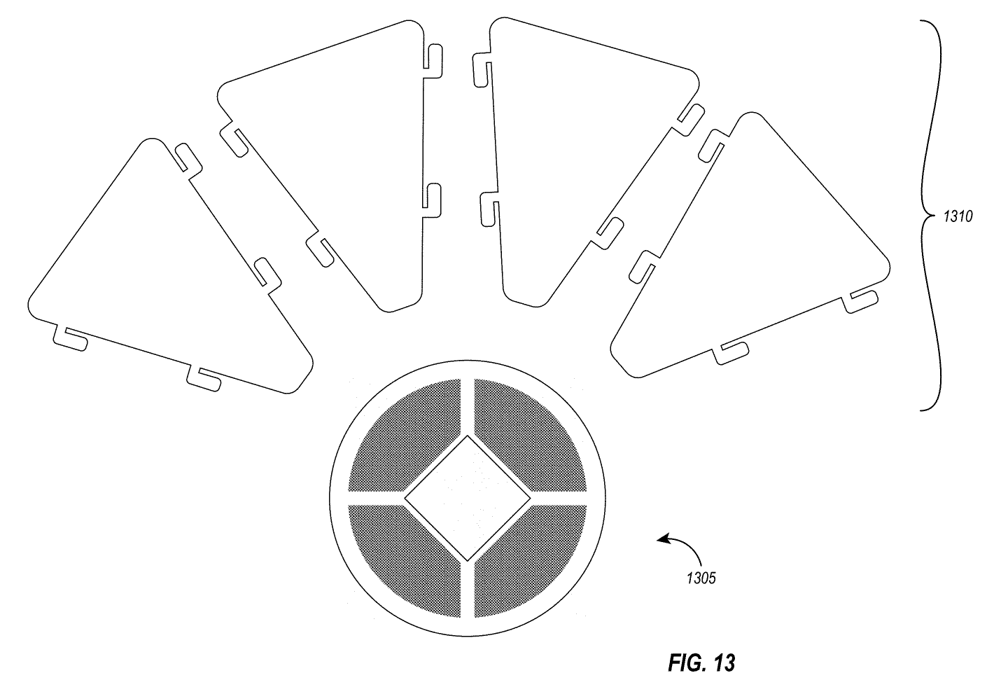

Turning now to FIG. 13, FIG. 13 shows an example scenario in which a multi-sided funnel has been completely disassembled. Here, FIG. 13 shows a base support 1305 and a multi-sided funnel 1310 that has been completely disassembled such that none of the walls are interlocked together (i.e., all four sets of locking mechanisms between the four walls have been disconnected). This enables the coffee filter support structure to be very compact and easy to pack.

Here, it will be appreciated that any type of locking mechanism may be used for connecting the walls together to form the multi-sided funnel 1310. For example, in some embodiments, the walls include a latch clasp so that one wall may be latched to another wall. In another embodiment, all of the walls are connected at a hinge with the exception of two adjoining walls. Here, these two adjoining walls are detachable from one another. Because the remaining walls are connected via hinges, the walls may be folded up into a compact unit. When the multi-sided funnel needs to be formed, the walls are unfolded from one another and the two adjoining walls are connected to thereby form the multi-sided funnel. Other embodiments include interlocking magnetic elements on the walls of the multi-sided funnel to facilitate attachment between the walls. Accordingly, from this disclosure it will be appreciated that any type of locking mechanism may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A filter support structure comprising:
a multi-sided funnel, the multi-side funnel being comprised of a plurality of interconnecting walls where each wall forms one side of the multi-sided funnel, each wall being connected to an adjoining wall via a latching mechanism; and
a base support that includes a central opening, a shape of the central opening corresponding to a number of walls that are included in the plurality of walls of the multi-sided funnel, whereby a portion of the multi-sided funnel is fittable within the central opening of the base support.

2. The filter support structure of claim 1, wherein the base support includes a plurality of holes surrounding the central opening.

3. The filter support structure of claim 1, wherein a top portion of each wall of the plurality of interconnecting walls is wider than a bottom portion of each wall of the plurality of interconnecting walls.

4. The filter support structure of claim 1, wherein the multi-sided funnel comprises four interconnecting walls, each wall being connected to two adjoining walls via the latching mechanism.

5. The filter support structure of claim 4, wherein the central opening of the base support has four sides and is shaped as a square.

6. The filter support structure of claim 1, wherein the latching mechanism includes a first tab and a first locking channel on a first side of each wall of the plurality of interconnecting walls and a second tab and a second locking channel on a second side of each wall of the plurality of interconnecting walls, wherein the first tab and the first locking channel are oriented in a direction opposite the orientation of the second tab and the second locking channel, such that the first tab and the first locking channel of one wall of the plurality of interconnecting walls are configured to removably interlock with the second tab and the second locking channel of another wall of the plurality of interconnecting walls when positioned in an interlocked position.

7. The filter support structure of claim 6, wherein the latching mechanism includes two first tabs and two first locking channels on the first side of each wall of the plurality of interconnecting walls and two second tabs and two second locking channels on the second side of each wall of the plurality of interconnecting walls.

8. The filter support structure of claim 1, wherein the multi-sided funnel is configured in size and shape to receive and support a coffee filter in a top opening of the multi-sided funnel.

9. A filter support structure comprising:
a multi-sided funnel that includes three or more interconnecting walls where each wall forms one side of the multi-sided funnel, each wall being connected to an adjoining wall via a latching mechanism; and
a base support that includes a central opening, wherein a shape of the central opening corresponds to a number of walls that are included in the three or more interconnecting walls of the multi-sided funnel when those walls are interlocked together to form the multi-sided funnel, whereby a portion of the multi-sided funnel is fittable within the central opening of the base support.

10. The filter support structure of claim 9, wherein the central opening has a diameter spanning a range between 8 mm and 30 mm.

11. The filter support structure of claim 10, wherein the diameter is 10 mm.

12. The filter support structure of claim 9, wherein the three or more interconnecting walls include four interconnecting walls.

13. The filter support structure of claim 9, wherein the base support includes one or more release vents.

14. A filter support structure comprising:
a multi-sided funnel that includes four interconnecting walls where each wall forms one side of the multi-sided funnel, each wall being connected to an adjoining wall via a latching mechanism; and
a base support that includes a central opening, wherein a shape of the central opening is a square so as to correspond to the four interconnecting walls of the multi-sided funnel when those four interconnecting walls are interlocked together to form the multi-sided funnel, whereby a portion of the multi-sided funnel is fittable within the central opening of the base support.
